(19) United States
(12) Patent Application Publication
(10) Pub. No.: US 2021/0382638 A1
(43) Pub. Date: Dec. 9, 2021

(54) DATA SCRAMBLER TO MITIGATE ROW HAMMER CORRUPTION

(71) Applicant: Intel Corporation, Santa Clara, CA (US)

(72) Inventors: Ronald ANDERSON, Lexington, SC (US); Lawrence D. BLANKENBECKLER, Cary, NC (US); Pietro FRIGO, Amsterdam (NL); Jaemon FRANKO, Gig Harbor, WA (US); Sreenivas MANDAVA, Los Altos, CA (US)

(21) Appl. No.: 17/411,944

(22) Filed: Aug. 25, 2021

(51) Int. Cl. G06F 3/06

(52) U.S. Cl. CPC G06F 3/0623; G06F 3/0604; G06F 3/0683; G06F 3/0659; G06F 3/0632

(57) ABSTRACT

A memory system includes a memory device having a memory array that stores data based on address bits, including a row address. The memory system includes a memory controller having scrambler circuitry to apply a data mask to scramble data to be stored in the memory array. The scrambler can apply the data mask to scramble data for a write operation. The data scrambler can unscramble data for a read operation. The data mask has a pseudorandom pattern based at least in part on the row address of the data to be written or read.

### FIELD

Descriptions are generally related to computer memory systems, and more particular descriptions are related to mitigation of data corruption due to row hammer conditions.

### BACKGROUND

Volatile memory devices, such as DRAM (dynamic random access memory) devices, have a known attack vector referred to as row hammer or row disturb. A row hammer attack can refer to a failure caused by repeated access to a target row or aggressor row within a time period, which causes a change in value of a victim row that is adjacent or proximate to the target/aggressor row. Repeated activation of the target row causes migration of charge across the passgate of the victim row. With repeated manipulation of a target row with a known pattern, an attacker can intentionally flip bits of victim rows.

The attacks have become very sophisticated, where an attacker can carefully manipulate bit flips to avoid error checking and correction (ECC) issues. The manipulation of data values without triggering an error can be referred to as silent data corruption (SDC). An uncorrectable error (e.g., a detectable, uncorrectable error (DUE)) can cause a system crash or system hang, which would disrupt the attack. Careful manipulation of the bits based on specific bit position of bit patterns can cause SDC, avoiding the triggering of uncorrectable errors, which avoids a system crash.

Many memory subsystems can employ one of various implementations of targeted row refresh (TRR), but TRR implementations have not proven completely effective in preventing row hammer conditions. Memory subsystems can also implement a data scrambler to randomize data across different addresses. However, even with data randomization and TRR, complex row hammer attacks on ECC systems can directly cause controlled SDCs, allowing an attacker to gain privileged access on these ECC based systems without causing a DUE.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1A is a block diagram of an example of a system in which data is scrambled with row address bits for row hammer mitigation.

FIG. 1B is a block diagram of an example of a system in which data is scrambled with row address bits and a per boot seed for row hammer mitigation.

FIG. 2 is a block diagram of an example of a system that performs row hammer mitigation with data scrambling based on row address.

FIG. 3 is a block diagram of an example of a system that performs row hammer mitigation with data scrambling based on row address.

FIG. 4 is a block diagram of an example of a memory subsystem in which different rows have different scrambling patterns for row hammer mitigation.

FIG. 5 is a diagrammatic representation of data scrambling with a common mask for all rows.

FIG. 6 is a diagrammatic representation of data scrambling with a mask based on row address.

FIG. 7 is a flow diagram of an example of a process for data write with scrambling based on row address.

FIG. 8 is a flow diagram of an example of a process for data read of data scrambled based on row address.

FIG. 9 is a block diagram of an example of a memory subsystem in which data scrambling based on row address can be implemented.

FIG. 10 is a block diagram of an example of a computing system in which data scrambling based on row address can be implemented.

FIG. 11 is a block diagram of an example of a mobile device in which data scrambling based on row address can be implemented.

FIG. 12 is a block diagram of an example of a multi-node network in which data scrambling based on row address can be implemented.

Descriptions of certain details and implementations follow, including non-limiting descriptions of the figures, which may depict some or all examples, and well as other potential implementations.

### DETAILED DESCRIPTION

As described herein, a memory system includes data scrambler that scrambles data at least in part based on row address of the memory access command. The memory device of the memory system includes a memory array that stores data based on address bits, including the row address. The memory system includes a memory controller having scrambler circuitry to apply a data mask to scramble data to be stored in the memory array. The scrambler can apply the data mask to scramble data for a write operation. The data scrambler can unscramble data for a read operation. The data mask has a pseudorandom pattern based at least in part on the row address of the data to be written or read.

In one example, the use of row address information can be in addition to other memory address information provided to the data scrambler. For example, in addition to row address information, the data scrambler can generate a data mask to scramble the data based on column address, bank address, rank address, or DIMM (dual inline memory module) address information.

The addition of the input of row address bits to the scrambler can introduce randomization into the data scrambling for adjacent rows, where adjacent rows apply different scrambling masks. The randomization means that adjacent rows will scramble data in different ways, reducing the likelihood of a rowhammer attack being successful, even for a complex attack taking advantage of ECC (error checking and correction) that corrects errors in some systems. The randomization can avoid silent data corruption (SDC), which can otherwise be used by an attacker to gain privileged access. Instead of SDC, the randomization of the data scrambling based on row address would result in a DUE (detected uncorrectable error), which allows the system to detect a problem and address it, such as by hanging the operating system.

It will be understood that the addition of row address bits to the data scrambler will not necessarily avoid rowhammer conditions, but will cause DUEs in place of SDCs in response to a rowhammer attack. Thus, a rowhammer attack can be prevented from leading to privilege escalation by an attacker.

In one example, the inclusion of the row address bits in the data scrambler provides two or more row address least significant bits (LSBs) as an input of the memory bus data scrambler computation. With the use of row address LSBs, neighboring rows are scrambled differently, reducing an attacker's control over data pattern manipulation between specific column bits of neighboring rows. As such, the attack should produce bit flips on columns unintended by the attacker, making a DUE significantly more likely than an SDC.

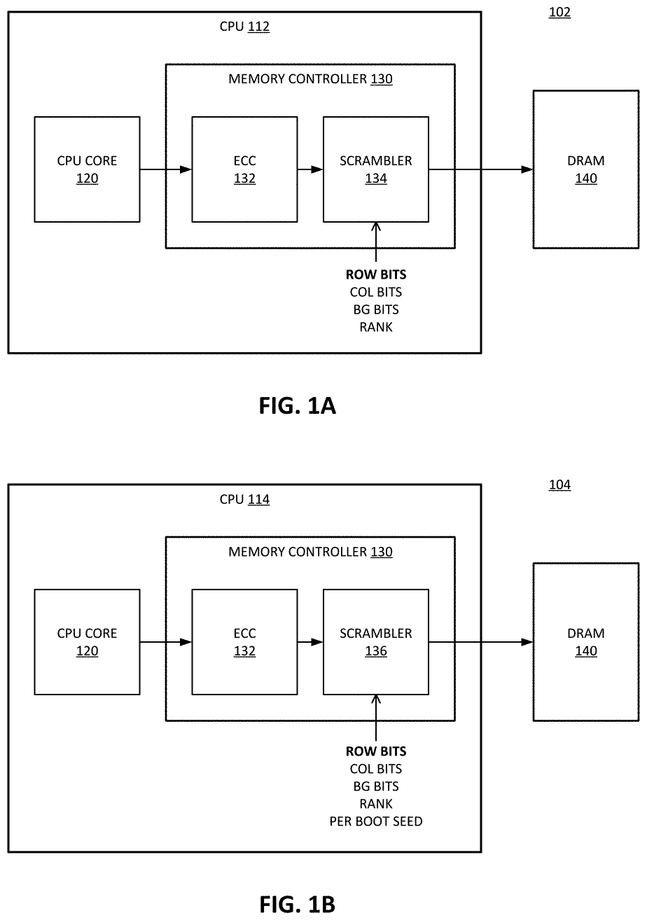

FIG. 1A is a block diagram of an example of a system in which data is scrambled with row address bits for row hammer mitigation. System 102 represents elements of a computing system with a host processor coupled to memory resources.

CPU (central processing unit) 112 represents the host processor, which executes instructions for system 102. In one example, CPU 112 represents a multicore processor, having multiple separate execution cores. CPU core 120 represent an execution core that performs operations that generate memory access requests. CPU 112 can include multiple CPU cores 120 that perform operations in parallel and send memory access requests to memory controller 130.

The execution of operations can generate changes to data that will be stored in memory, and the execution of operations can request data for execution that will request data stored in memory. DRAM (dynamic random access memory) 140 represents the memory for system 102. DRAM 140 can represent multiple separate memory devices, such as multiple DRAMs in a DIMM (dual inline memory module).

DRAM 140 represents a memory device that has a memory array to store data. DRAM 140 stores data in its memory array based on row address, column address, bank address, bank group, and rank. Rank is typically addressed by chip select (CS#). DRAM 140 connects with CPU 112 via a command bus for commands and a data bus to exchange data. DRAM 140 can represent multiple memory devices coupled to the data bus.

CPU core 120 provides requests for data access to memory controller 130. Memory controller 130 manages access to DRAM 140. Memory controller 130 receives memory access requests for CPU 112 and generates commands to access DRAM 140. Memory controller 130 can identify physical addresses for host addresses in the requests from CPU core 120.

In one example, memory controller 130 includes ECC (error checking and correction) 132. ECC 132 represents circuitry or logic in memory controller 130 to perform ECC operations. For writes, ECC 132 generates ECC bits, which are metadata bits used to perform error detection and correction when data is read from DRAM 140. For reads, ECC 132 applies ECC bits received with the read to perform the error detection and error correction.

Memory controller 130 includes scrambler 134 to perform scrambling of write data for write operations and unscrambling of read data for read operations. Scrambler 134 can be referred to as a memory data scrambler. Scrambler 134 includes scrambler circuitry that applies a data mask to scramble the data that is exchanged over a data bus that data to send over the data bus. In one example, scrambler applies XOR (exclusive OR) circuitry to generate a pseudorandom data mask for outgoing data (DQ lines) on a write, and then a reverse data mask process on a read. Thus, the data mask applied by scrambler 134 has a pseudorandom pattern based in part on the row address.

In one example, system 102 includes row bits as an input to scrambler 134 to provide the scrambling and unscrambling of memory data. Traditional scramblers apply the same data mask to neighboring rows. With the application of row bits as an input to scrambler 134, system 102 can provide different data masks to neighboring rows. In addition to row bits, scrambler 134 can receive column (COL) bits, bank group (BG) bits, and rank bits. Reference to “bits” can be a subset of the total number of bits. For example, the rows bits can include two or more bits of the total number of address bits in the row address. Similarly, one or more bits can be applied from column address, one or more bits of the bank group, and one or more bits of the rank.

The bits applied to create the data mask can be selected bits of the row address. In one example, at least two LSBs of the row address are the selected bits input to scrambler 134. The bits applied to create the data mask can be selected bits of column address bits, selected bits of rank address bits, selected bits of bank address, selected bits of bank group address, or a combination of selected bits of one or more of these address bits.

Scrambler 134 can apply different data masks to different rows to scramble data for a write, and can reverse the scramble operation to return read data to original values based for a read. The use of row bits to apply different scrambling for different rows is probabilistically likely to avoid pathological data patterns which can cause power delivery or signal integrity issues.

FIG. 1B is a block diagram of an example of a system in which data is scrambled with row address bits and a per boot seed for row hammer mitigation. System 104 represents elements of a computing system with a host processor coupled to memory resources. System 104 represents a system in accordance with an example of system 102. System 104 includes CPU core 120, memory controller 130, ECC 132, and DRAM 140, which can be in accordance with what is described for system 102.

CPU (central processing unit) 114 represents an example of a processor that includes a memory controller with a data scrambler that also provides scrambling based on a per boot seed value. Memory controller 130 includes scrambler 136 to perform scrambling of write data for write operations and unscrambling of read data for read operations. Scrambler 136 provides an example of a scrambler in accordance with scrambler 134. In addition to row bits, column bits, bank bits, bank group bits, and rank bits, scrambler 136 can receive a per boot seed to generate a pseudorandom data mask pattern.

The per boot seed refers to a value that changes with each boot of system 104. Thus, the per boot seed can be a pseudorandom value generated each time the system is reset or power cycled. As such, when memory controller 130 is booted, the seed value changes. With a per boot seed value, any attack that results in the system hanging due to uncorrectable errors, the per boot value will change, resulting in different mask patterns, meaning prior attack patterns will not produce the same results. With the application of row bits to the scrambler data mask, the system will generate uncorrectable errors instead of SDCs, resulting in a reboot of the system, and thus, a change in scrambler pattern.

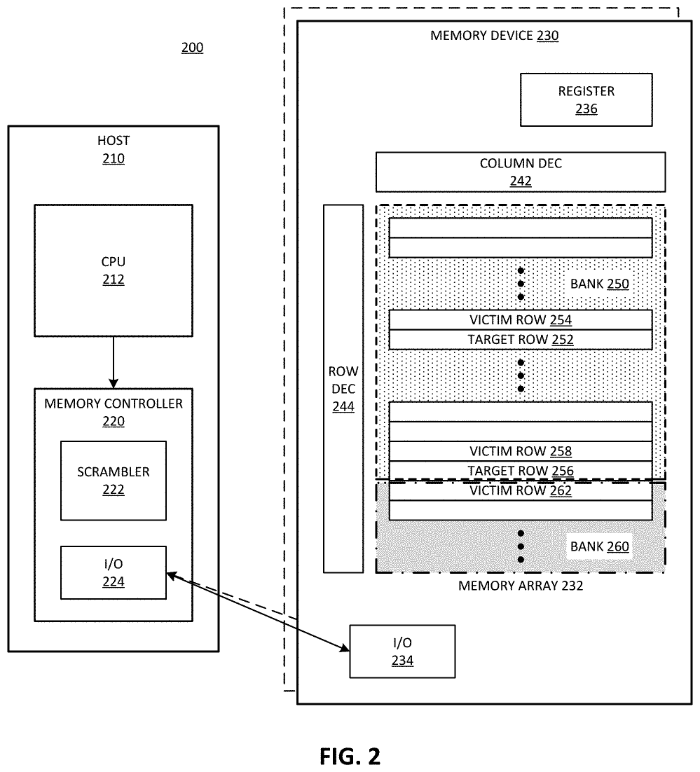

FIG. 2 is a block diagram of an example of a system that performs row hammer mitigation with data scrambling based on row address. System 200 represents a system in accordance with an example of system 102 or an example of system 104.

System 200 includes memory device 230 coupled to memory controller 220. Memory device 230 can include any type of memory technology that has adjacent rows of memory cells, where data is accessible via a wordline or the equivalent. In one example, memory device 230 includes DRAM technology. In one example, system 200 includes multiple memory devices 230.

Memory controller 220 is part of host 210, which represents a host system of which memory device 230 is part. Host 210 includes CPU 212, which represents one or more processors or processing resources for the host. CPU 212 generates memory access requests for memory device 230. Memory controller 220 can be an integrated memory controller, which is part of the CPU die, or a discrete component coupled to the CPU die.

Memory device 230 includes memory array 232, which represents an array of memory cells or storage cells. A memory cell stores a bit of data, or multiple bits for a multilevel cell. Memory array 232 includes a representation of potential row hammer conditions. For purposes of example, memory array 232 shows bank 250 and bank 260. It will be understood that memory array 232 can include multiple banks. In general, a bank or a sub-bank of memory includes memory cells that are addressable separately from memory cells of another bank or sub-bank.

Memory device 230 includes column decoder (DEC) 242 which represents circuitry to apply charge to a column based on an access command. In one example, the circuitry selects a column in response to a column address strobe (CAS) command. Memory device 230 includes row decoder (DEC) 244 which represents circuitry to apply selection voltages to rows based on a memory access command. In one example, the circuitry selects a column in response to a row address strobe (RAS) command.

I/O (input/output) 224 represents a hardware interface of memory controller 220 to connect to memory device 230. I/O 224 can include pins, pads, signal lines, drivers, receivers, or other hardware, or a combination of hardware components. I/O 224 can be controlled by control logic that configures and manages termination and driver components. I/O 234 represents I/O on memory device 230. Memory device 230 can interface with memory controller 220 via I/O 234 of memory device 230 and I/O 224 of memory controller 220. I/O 224 and I/O 234 provide interface hardware to couple to a data bus that interconnects memory controller 220 with memory device 230.

Memory device 230 includes register 236, which represents one or more registers or storage locations to store configuration information or values related to the operation of memory device 230. In one example, register 236 includes one or more mode registers. In one example, register 236 includes configuration information to control the operation memory device 230.

For an illustration of a row hammer condition, memory array 232 includes target row 252 in bank 250. A physically proximate row or a physically adjacent row can suffer from unintentional programming or disturb of one or more values stored in the row based on repeated access to target row 252 within a time period prior to a refresh operation on the row. The repeated access results in charge migration based on ones in the target row adjacent zeros in the victim row.

Victim row 254 represents a row that is subject to row hammer when target row 252 is repeatedly accessed. When victim row 254 is at risk of a row hammer event, target row 252 can be referred to as an aggressor row. There may be another row in bank 250 that is a victim row to target row 252.

In one example, bank 250 also includes target row 256. Consider that target row 256 is at or near a bank boundary. It will be understood that the rows in memory array 232 may have a spacing that is not different even if the rows are in different banks or sub-banks. Rather, the separation of one bank or sub-bank to another can be defined by selection or decode hardware elements. Thus, depending on the architecture of the physical layout of the rows, a row on the boundary of bank 260 could also be at risk for a row hammer event based on access to target row 256. In one example, repeated access to a target row can cause a disturb of multiple adjacent rows. In as illustrated, target row 256 can result in row hammer events to both victim row 258 of bank 250 and victim row 262 of bank 260.

Memory controller 220 includes scrambler 222. Scrambler 222 can include scrambling logic in accordance with system 102 or system 104. Scrambler 222 scrambles write data to send to memory device 230. Scrambler 222 can unscramble read data received from memory device 230. Scrambler 222 provides a data mask to scramble data based at least in part on row address bits. The application of row bits to the operation of scrambler 222 causes different masks to be applied to neighboring rows.

System 200 provides representations of row hammer conditions for purposes of understanding the row hammer condition. However, with scrambler 222 generating a data mask based on row address bits, the row hammer conditions described will not result in targeted SDC for data manipulation that can result in privilege escalation in system 200. The target row and victim row relationships will still exist, but the hammer of the target row will result in bit manipulation of the victim rows in ways that is not controllable by an attacker for SDC manipulation.

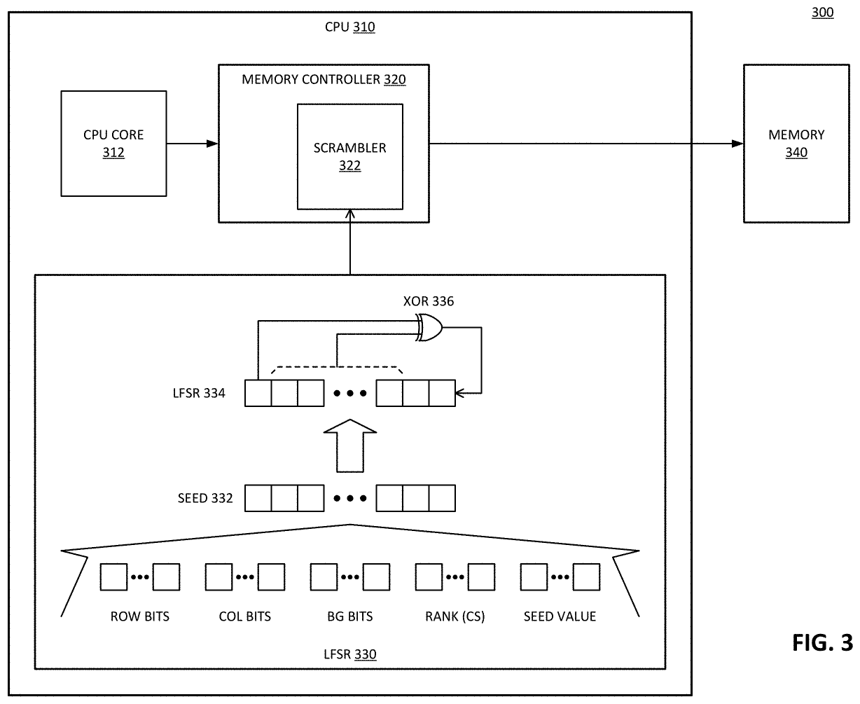

FIG. 3 is a block diagram of an example of a system that performs row hammer mitigation with data scrambling based on row address. System 300 illustrates a system in accordance with an example of system 102 or system 104 or system 200.

CPU 310 represents a processor for system 300. CPU 310 is part of a host hardware system that provides a hardware environment for system 300. CPU 310 can be part of a motherboard, for example. CPU 310 executes a host operating system (OS) that provides a host software environment for system 300. The execution of the software generates the memory access requests including reads and writes in which data is exchanged between CPU 310 and memory 340.

Memory 340 can represent one or multiple memory devices including a memory array that stores data based on address information provided by memory controller 320. The address information can direct writes to specific areas of memory 340 and read from specific areas of memory 340.

CPU 310 includes one or more CPU cores 312 that execute software that generates memory access requests to memory controller 320. Memory controller 320 includes scrambler 322. Scrambler 322 performs scrambling and unscrambling of data for memory access requests to memory 340.

In one example, scrambler 322 includes LFSR (linear feedback shift register) 330. In one example, LFSR 330 is separate from scrambler 322. In one example, LFSR 330 is separate from scrambler 322 and still part of memory controller 320. LFSR 330 can provide a pseudorandom bit pattern as a data mask for scrambler 322 to apply to data.

LFSR 330 provides a representation of a linear feedback shift register. Seed 332 represents a seed value to use for the linear feedback shift operation. The linear feedback shift operation includes multiple iterations of operations on selected data bits from the seed value, shifting the seed elements to the left, and repeating the operations. The operations continue for a set number of iterations.

LFSR 334 represents seed 332 for the linear feedback shift operation. In the operation, at least two bits of the LFSR 334 are XORed with XOR circuit XOR 336. Typically, the last bit of LFSR 334 and another selected bit of LFSR 334 will be XORed, with the result fed back to the LSB of LFSR 334 when the LFSR value is shifted left.

As illustrated in LFSR 330, seed 332 can be a combination of bits including row bits, column (COL) bits, bank or bank group (BG) bits, rank bits (e.g., the chip select or CS value), and a seed value. In one example, the seed value is a variable seed value that changes when system 300 is booted, and consequently, when memory controller 320 is booted or reset. It will be understood that seed 332 can be any combination of bits. The bits from a particular source are not necessarily input contiguously into seed 332. For example, seed 332 can include multiple row bits, which are input to non-adjacent bit locations. In one example, one or more sets of source bits are provided in contiguous bit locations. In one example, one or more sets of source bits are provided in non-contiguous bit locations. In one example, one or more sets of source bits are provided in contiguous bit locations, while one or more other sets of source bits are provided in non-contiguous bit locations.

In one example, the row bits are or include LSB row bits to seed LFSR 334. It will be understood that for a row hammer attack to result in privilege escalation, the attacker needs precise control of the row hammer induced bit flips. The application of row address bits adds uncertainty to the operation of scrambler 322, with different masks for different adjacent rows.

LFSR 330 can represent one or more LFSR circuits to generate an XOR mask for scrambler 322. In one example, scrambler 322 XORs the data for a memory access transaction with the data mask, and sends the XOR result as the scrambled data. In one example, LFSR 330 is seeded by the current address for the write or read transaction. Thus, LFSR 330 and scrambler 322 can use various column bits, rank bits, bank or bank group bits, and a fixed input seed value or a programmable input seed value.

In system 300, LFSR 330 is a scrambler LFSR that is part by row bits. In one example, the row bits include row bits [0:1}. In one example, the row bits include bits [0:N−1], where N is a value greater than 2. In one example, the row bits alter the output of LFSR 330 whenever the row address changes in its least significant bits. With such operation, different system 300 will have a different LFSR output on accesses to neighboring rows. Consequently, the data pattern placed in memory will be randomly modified on neighboring rows, distinctly across rows. Traditional scramblers have the same scrambling pattern for neighboring rows, allowing an attacker to create SDCs by use of a constant pattern written from software, because neighboring rows could be programmed to a constant pattern.

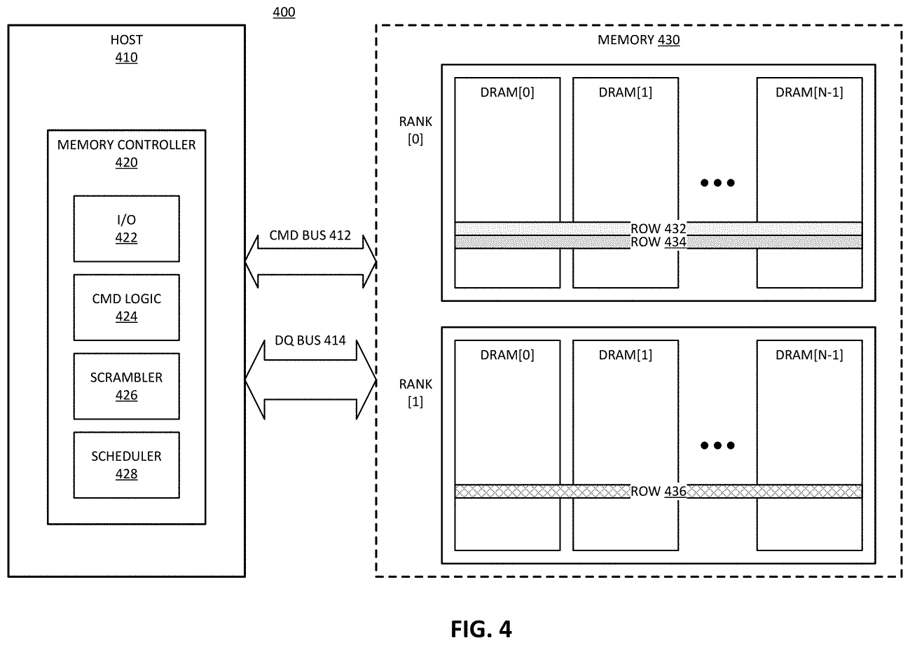

FIG. 4 is a block diagram of an example of a memory subsystem in which different rows have different scrambling patterns for row hammer mitigation. System 400 represents elements of a computing system. System 400 represents a system in accordance with an example of system 102, system 104, system 200, or system 300. System 400 can be considered to have a memory subsystem with memory controller 420 and memory 430.

Host 410 represents the hardware platform that controls the memory subsystem. Host 410 includes memory controller 420, which can be integrated onto a processor device. Memory controller 420 includes I/O (input/output) 422 to connect to memory 430. I/O includes connectors, signal lines, drivers, and other hardware to interconnect the memory devices to host 410. I/O 422 can include command I/O as represented by command (CMD) bus 412, and data I/O as represented by DQ (data) bus 414. CMD bus 412 includes command signal lines that enable memory controller 420 to send commands to memory 430. DQ bus 414 includes multiple data signal lines. For an M-bit interface, DQ bus 414 will include DQ[0:M−1] for each of the multiple memory device DQ interfaces.

Memory controller 420 includes command (CMD) logic 424 to generate commands for memory. The commands can be commands for data access (such as Read, Write, Refresh, or other commands), or commands for configuration (such as mode register commands). Memory controller 420 includes scheduler 428 to schedule when to send commands in a sequence of operations.

Memory 430 represents a memory module. System 400 illustrates two ranks of memory devices in memory 430. A rank refers to a collection or group of memory devices that share a select line. Thus, memory devices in a rank will execute operations in parallel. Rank[0] and Rank[1] are illustrated to include N DRAM devices or DRAMs. Typically, a system with multiple ranks will have the same number of DRAMs in each of the ranks.

In one example, memory controller 420 includes scrambler 426 to scramble data for a write operation. In one example, scrambler 426 also reverses the scrambling for data associated with a read operation. In system 400, scrambler 426 generates scrambled data based on row address bits. Based on the row address bits, different scrambling will be applied to different rows.

Thus, consider row 432 of Rank[0] and row 436 of Rank[1]. Being in different ranks, even if they were rows having common bank addresses, there scrambling could be made different based on the different rank addresses. In a traditional system, even if row 432 and row 436 had different scrambling patterns, row 432 and row 434 would traditionally have the same scrambling pattern if they had the same bank address.

In system 400, scrambler 426 applies scrambling based on row address bits, which means that row 432 and row 434 would have different scrambling patterns, even if they had command bank addresses and are in the same rank. Thus, differences in the scrambling pattern for neighboring rows would significantly reduce the likelihood a row hammer attack could result in expected bit flips that would cause a silent data corruption. With different scrambling patterns, data send over DQ bus 414 would be randomized based on a known pattern written to the rows, even for adjacent rows.

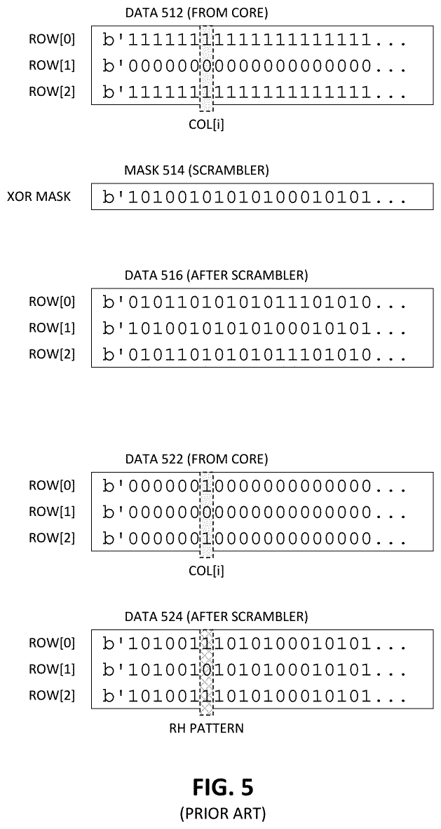

FIG. 5 is a diagrammatic representation of data scrambling with a common mask for all rows in accordance with a known system implementation. In traditional scrambling, a common mask is applied to all rows, and an attack can perform a targeted manipulation of adjacent row data patterns.

Data 512 represents data from a CPU core to be written to memory. For purposes of illustration, the rows illustrated are Row[0], Row[1], and Row[2]. It will be understood that any row address can be used. For purposes of illustration, the bit values of Rows[0:2] at column i (Col[i]). Mask 514 represents an XOR mask from the scrambler based on traditional scrambling that does not apply row address information.

Data 516 represents data 512 after mask 514 has been applied (bitwise XOR of column bits of data 512 with column bits of mask 514). Mask 514 appears to be a random XOR mask, but when the data in the rows is not random (as in Row[0:2]), the resulting XOR is not random. Thus, with data 512 have the same data at Row[0] and Row[2], with the inverse of the data at Row[1], data 516 has the same pattern of the same data at Row[0] and Row[2], with the inverse at Row[1]. As such, an attacker can use these data relationships to synthesize patterns which can evade ECC detection and cause silent data corruption.

Data 512 represents a first step in such an attack, writing all ones to Row[0] and Row[2] with all zeros to Row[1]. The attacker can observe data 516 to determine the operation of the scrambler and identify cross-row data dependency.

Data 522 represents a modification to the data patterns written to Row[0:2], with Row[0] and Row[2] matching the data pattern of Row[1] (in the example, all zeros), except for the bits of Col[i] in Row[0] and Row[2], which have been changed to ones. Data 524 represents the data after application of the scrambler. With the data pattern of data 522, all the patterns stored in memory will have the same polarity across rows, for each individual column, except for Col[i], which the attack software selected to be different. The physical mechanism that causes rowhammer is suppressed when data polarities match across rows, and only yields errors when the data polarities differ. Thus, the only column in data 524 that can cause a rowhammer failure is Col[i], and that column is controllable by software.

In ECC memory, a single bit failure (SBE or single bit error) is always correctable with a memory ECC code. Thus, a failure at Col[i] in data 524 caused by the software by a rowhammer attack is guaranteed to only create CEs, avoiding the creation of DUEs. DUEs tend to crash the system, which does not allow a path for privilege escalation.

Additionally, CEs cause a latency impact when they occur, due to the memory subsystem utilizing a data correction path (which can include correcting, logging, performing a demand scrub, or other operations). The latency provides a way for the attack software to detect that a CE occurred, by detection of the latency spike. Thus, the software can build a library of known columns that can fail in a target row, and it can compile the library without crashing the system.

With knowledge of the ECC implementation, the attacker can flip multiple bits in tandem during the same rowhammer attack, flipping bits in multiple selected columns simultaneously in Row[0] and Row[2], resulting in an SDC. An SDC is typically caused by a multibit error (MBE) that cannot be detected and which has a known failing result returned to the CPU. SDCs provide a possibility for privilege escalation.

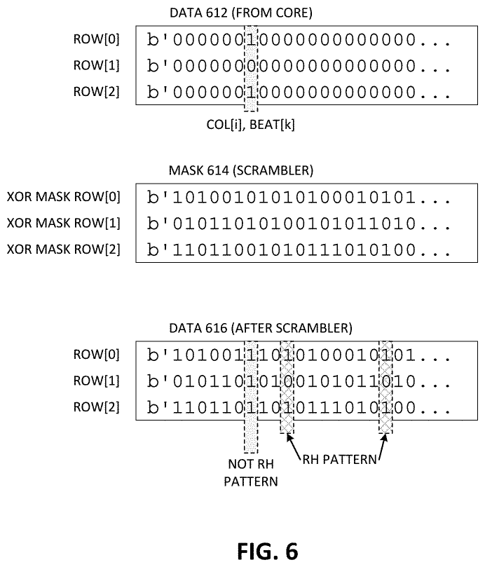

FIG. 6 is a diagrammatic representation of data scrambling with a mask based on row address. In contrast to traditional scrambling, the XOR mask can be generated from a per row computation or a computation based on per row data. The application of row bits in the seeding of the mask greatly reduces a hacker's per-column control of the data patterns.

Data 612 represents data from a CPU core to be written to memory. For purposes of illustration, the rows illustrated are Row[0], Row[1], and Row[2]. It will be understood that any row address can be used. For purposes of illustration, the bit values of Rows[0:2] at column i (Col[i]).

Mask 614 represents an XOR mask from the scrambler based on scrambling with row address information. Mask 614 includes XOR mask Row[0] to scramble Row[0], XOR mask Row[1] to scramble Row[1], and XOR mask Row[2] to scramble Row[2]. It will be observed that the XOR masks for Row[0:2] are different from each other, because each one is seeded with different row bits, providing a more randomized output.

Data 616 represents data 612 after mask 614 has been applied (bitwise XOR of column bits of data 612 with column bits of respective row mask of mask 614). It will be observed that even though data 612 has the same value for Row[0] and Row[2], the resulting scrambling of these rows results in different data patterns. Similarly, even though Row[1] differs from Row0] and Row[2] by only a single bit, the data pattern of Row[1] after scrambling appears much more randomized.

Whereas an attacker could traditionally input data 612 in the system in the attempt to target a bit flip of Col[i], data 616 illustrates that the scrambled data patterns result in a column pattern of ‘111’, which will not result in a rowhammer bit flip. Additionally, it can be observed that other columns have data patterns that are likely to result in rowhammer bit flips. Thus, columns that the attacker would try to target can result in rowhammer conditions at other columns, which results in a likelihood that an uncorrectable error will occur. With uncorrectable errors, SDCs are not possible, and the attack will result in a system crash rather than SDC privilege escalation.

Thus, with row bit information included in the scrambling, an attacker cannot avoid DUEs, because they cannot limit the number of errors occurring in a rowhammer attack. Furthermore, even if a CE occurs, the attack cannot know which bits caused the flip. Thus, the application of row address information to the data scrambler randomizes the scrambling of the data, removing the precise control over the data needed by an attacker to synthesize failures together to yield an SDC.

Furthermore, in a system that applies a per system seed and a per boot seed will further randomize the scrambler input. Thus, even with exact knowledge of the scrambler, per-boot random seed values will cause an attempted attack to yield DUEs, resulting in a system crash. The data dependency in specific columns between rows can be removed by the inclusion of row address information. The data dependency can be further removed by a per-boot random seed value. The lack of data dependency removes the control needed for targeted SDC.

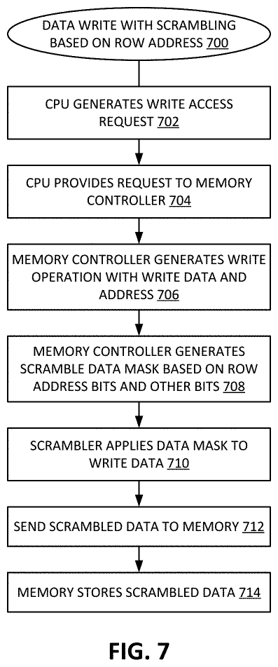

FIG. 7 is a flow diagram of an example of a process for data write with scrambling based on row address. Process 700 represents a process for scrambling data for a write operation for a system in accordance with an example of system 102, system 104, system 200, system 300, or system 400. The scrambling includes row address information in accordance with any example herein.

In one example, a CPU generates a write access request, at 702. In place of a CPU, a GPU (graphics processing unit), coprocessor, or other system processor can generate the write operation to write data to memory. The CPU or processor provides the request to the memory controller with the data to be written, at 704.

In one example, the memory controller generates one or more commands for a write operation with the write data and address of memory to write the data, at 706. In one example, the memory controller generates a scramble data mask based on row address bits and other bits, at 708. In one example, the other bits include per-boot random number or pseudorandom value generated for each boot of the memory system. In one example, generating the data mask includes generating a pseudorandom bit pattern with a linear feedback shift register (LFSR) based on a seed value, the seed value including the row address.

A scrambler in the memory controller applies the data mask to the write data, at 710. The result of the application of the data mask to the write data is scrambled data. It will be understood that with the application of row address bits, a different data mask will be applied to adjacent rows of data. The memory controller can then send the scrambled data to memory as part of a write transaction, at 712. The memory stores the scrambled data to the address indicated in the write command, at 714.

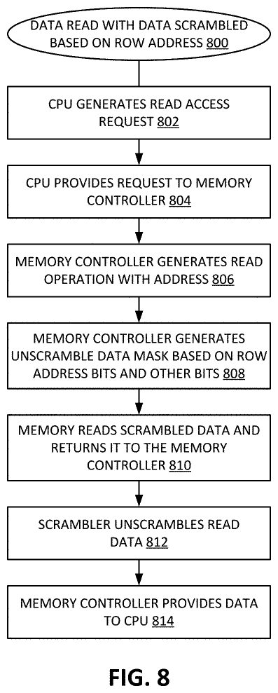

FIG. 8 is a flow diagram of an example of a process for data read of data scrambled based on row address. Process 800 represents a process for reversing the scrambling of data for a read operation for a system in accordance with an example of system 102, system 104, system 200, system 300, or system 400. The reverse of the scrambling can be referred to as unscrambling the data, and will include an operation based on row address information to reverse the scrambling operation.

In one example, a CPU generates a read access request, at 802. In place of a CPU, a GPU (graphics processing unit), coprocessor, or other system processor can generate the write operation to write data to memory. The CPU or processor provides the request to the memory controller with the address to be read, at 804.

In one example, the memory controller generates one or more commands for a read operation with the address of memory to read, at 806. In one example, the memory controller generates an unscramble data mask based on row address bits and other bits, at 808. In one example, the other bits include per-boot random number or pseudorandom value generated for each boot of the memory system. In one example, generating the data mask includes generating a pseudorandom bit pattern with a linear feedback shift register (LFSR) based on a seed value, the seed value including the row address.

In response to the read request, the memory reads the scrambled data stored at the address and returns it to the memory controller over the data bus, at 810. A scrambler in the memory controller applies the data mask to the read data, at 812. The result of the application of the data mask to the read data is the original data, without scrambling applied. It will be understood that with the application of row address bits, a different data mask will be applied to adjacent rows of data to store in the memory, and the row address bits will need to be applied to reverse the scrambling operation when the data is read back from memory. The memory controller can then provide the data to the CPU or processor that requested the data, at 814.

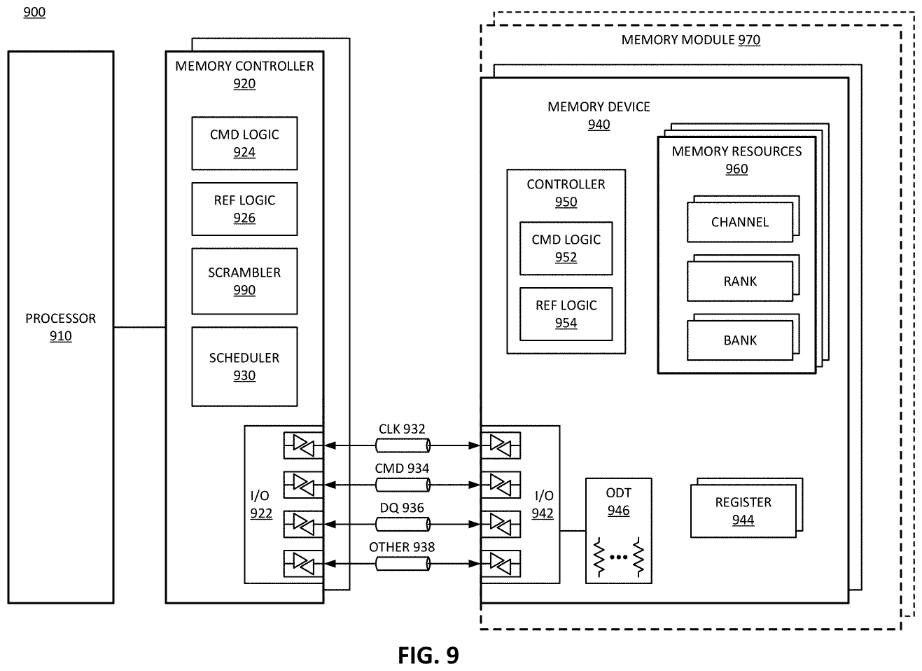

FIG. 9 is a block diagram of an example of a memory subsystem in which data scrambling based on row address can be implemented. System 900 includes a processor and elements of a memory subsystem in a computing device. System 900 represents a system in accordance with an example of system 102, system 104, system 200, system 300, or system 400.

In one example, memory controller 920 includes scrambler 990. Scrambler 990 can scramble data for write operations in accordance with any example herein. Scrambler 990 applies a data mask based at least in part on row address bits, which randomizes the data mask used for adjacent rows of data. Scrambler 990 can reverse the scrambling of the data when data is read from memory in accordance with any example herein.

Processor 910 represents a processing unit of a computing platform that may execute an operating system (OS) and applications, which can collectively be referred to as the host or the user of the memory. The OS and applications execute operations that result in memory accesses. Processor 910 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 900 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR4 (double data rate version 4, JESD79-4, originally published in September 2012 by JEDEC (Joint Electron Device Engineering Council, now the JEDEC Solid State Technology Association), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235A, originally published by JEDEC in November 2015), DDR5 (DDR version 5, originally published by JEDEC in July 2020), LPDDR5 (LPDDR version 5, JESD209-5, originally published by JEDEC in February 2019), HBM2 ((HBM version 2), currently in discussion by JEDEC), or others or combinations of memory technologies, and technologies based on derivatives or extensions of such specifications.

Memory controller 920 represents one or more memory controller circuits or devices for system 900. Memory controller 920 represents control logic that generates memory access commands in response to the execution of operations by processor 910. Memory controller 920 accesses one or more memory devices 940. Memory devices 940 can be DRAM devices in accordance with any referred to above. In one example, memory devices 940 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 920 manages a separate memory channel, although system 900 can be configured to have multiple channels managed by a single controller, or to have multiple controllers on a single channel. In one example, memory controller 920 is part of host processor 910, such as logic implemented on the same die or implemented in the same package space as the processor.

Memory controller 920 includes I/O interface logic 922 to couple to a memory bus, such as a memory channel as referred to above. I/O interface logic 922 (as well as I/O interface logic 942 of memory device 940) can include pins, pads, connectors, signal lines, traces, or wires, or other hardware to connect the devices, or a combination of these. I/O interface logic 922 can include a hardware interface. As illustrated, I/O interface logic 922 includes at least drivers/transceivers for signal lines. Commonly, wires within an integrated circuit interface couple with a pad, pin, or connector to interface signal lines or traces or other wires between devices. I/O interface logic 922 can include drivers, receivers, transceivers, or termination, or other circuitry or combinations of circuitry to exchange signals on the signal lines between the devices. The exchange of signals includes at least one of transmit or receive. While shown as coupling I/O 922 from memory controller 920 to I/O 942 of memory device 940, it will be understood that in an implementation of system 900 where groups of memory devices 940 are accessed in parallel, multiple memory devices can include I/O interfaces to the same interface of memory controller 920. In an implementation of system 900 including one or more memory modules 970, I/O 942 can include interface hardware of the memory module in addition to interface hardware on the memory device itself. Other memory controllers 920 will include separate interfaces to other memory devices 940.

The bus between memory controller 920 and memory devices 940 can be implemented as multiple signal lines coupling memory controller 920 to memory devices 940. The bus may typically include at least clock (CLK) 932, command/address (CMD) 934, and write data (DQ) and read data (DQ) 936, and zero or more other signal lines 938. In one example, a bus or connection between memory controller 920 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 900 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 920 and memory devices 940. An example of a serial bus technology is 86106 encoding and transmission of high-speed data with embedded clock over a single differential pair of signals in each direction. In one example, CMD 934 represents signal lines shared in parallel with multiple memory devices. In one example, multiple memory devices share encoding command signal lines of CMD 934, and each has a separate chip select (CS_n) signal line to select individual memory devices.

It will be understood that in the example of system 900, the bus between memory controller 920 and memory devices 940 includes a subsidiary command bus CMD 934 and a subsidiary bus to carry the write and read data, DQ 936. In one example, the data bus can include bidirectional lines for read data and for write/command data. In another example, the subsidiary bus DQ 936 can include unidirectional write signal lines for write and data from the host to memory, and can include unidirectional lines for read data from the memory to the host. In accordance with the chosen memory technology and system design, other signals 938 may accompany a bus or sub bus, such as strobe lines DQS. Based on design of system 900, or implementation if a design supports multiple implementations, the data bus can have more or less bandwidth per memory device 940. For example, the data bus can support memory devices that have either a x4 interface, a x8 interface, a x16 interface, or other interface. The convention “xW,” where W is an integer that refers to an interface size or width of the interface of memory device 940, which represents a number of signal lines to exchange data with memory controller 920. The interface size of the memory devices is a controlling factor on how many memory devices can be used concurrently per channel in system 900 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 940 and memory controller 920 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 940 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 940 represent memory resources for system 900. In one example, each memory device 940 is a separate memory die. In one example, each memory device 940 can interface with multiple (e.g., 2) channels per device or die. Each memory device 940 includes I/O interface logic 942, which has a bandwidth determined by the implementation of the device (e.g., x16 or x8 or some other interface bandwidth). I/O interface logic 942 enables the memory devices to interface with memory controller 920. I/O interface logic 942 can include a hardware interface, and can be in accordance with I/O 922 of memory controller, but at the memory device end. In one example, multiple memory devices 940 are connected in parallel to the same command and data buses. In another example, multiple memory devices 940 are connected in parallel to the same command bus, and are connected to different data buses. For example, system 900 can be configured with multiple memory devices 940 coupled in parallel, with each memory device responding to a command, and accessing memory resources 960 internal to each. For a Write operation, an individual memory device 940 can write a portion of the overall data word, and for a Read operation, an individual memory device 940 can fetch a portion of the overall data word. The remaining bits of the word will be provided or received by other memory devices in parallel.

In one example, memory devices 940 are disposed directly on a motherboard or host system platform (e.g., a PCB (printed circuit board) on which processor 910 is disposed) of a computing device. In one example, memory devices 940 can be organized into memory modules 970. In one example, memory modules 970 represent dual inline memory modules (DIMMs). In one example, memory modules 970 represent other organization of multiple memory devices to share at least a portion of access or control circuitry, which can be a separate circuit, a separate device, or a separate board from the host system platform. Memory modules 970 can include multiple memory devices 940, and the memory modules can include support for multiple separate channels to the included memory devices disposed on them. In another example, memory devices 940 may be incorporated into the same package as memory controller 920, such as by techniques such as multi-chip-module (MCM), package-on-package, through-silicon via (TSV), or other techniques or combinations. Similarly, in one example, multiple memory devices 940 may be incorporated into memory modules 970, which themselves may be incorporated into the same package as memory controller 920. It will be appreciated that for these and other implementations, memory controller 920 may be part of host processor 910.

Memory devices 940 each include one or more memory arrays 960. Memory array 960 represents addressable memory locations or storage locations for data. Typically, memory array 960 is managed as rows of data, accessed via wordline (rows) and bitline (individual bits within a row) control. Memory array 960 can be organized as separate channels, ranks, and banks of memory. Channels may refer to independent control paths to storage locations within memory devices 940. Ranks may refer to common locations across multiple memory devices (e.g., same row addresses within different devices) in parallel. Banks may refer to sub-arrays of memory locations within a memory device 940. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 940 include one or more registers 944. Register 944 represents one or more storage devices or storage locations that provide configuration or settings for the operation of the memory device. In one example, register 944 can provide a storage location for memory device 940 to store data for access by memory controller 920 as part of a control or management operation. In one example, register 944 includes one or more Mode Registers. In one example, register 944 includes one or more multipurpose registers. The configuration of locations within register 944 can configure memory device 940 to operate in different “modes,” where command information can trigger different operations within memory device 940 based on the mode. Additionally or in the alternative, different modes can also trigger different operation from address information or other signal lines depending on the mode. Settings of register 944 can indicate configuration for I/O settings (e.g., timing, termination or ODT (on-die termination) 946, driver configuration, or other I/O settings).

In one example, memory device 940 includes ODT 946 as part of the interface hardware associated with I/O 942. ODT 946 can be configured as mentioned above, and provide settings for impedance to be applied to the interface to specified signal lines. In one example, ODT 946 is applied to DQ signal lines. In one example, ODT 946 is applied to command signal lines. In one example, ODT 946 is applied to address signal lines. In one example, ODT 946 can be applied to any combination of the preceding. The ODT settings can be changed based on whether a memory device is a selected target of an access operation or a non-target device. ODT 946 settings can affect the timing and reflections of signaling on the terminated lines. Careful control over ODT 946 can enable higher-speed operation with improved matching of applied impedance and loading. ODT 946 can be applied to specific signal lines of I/O interface 942, 922 (for example, ODT for DQ lines or ODT for CA lines), and is not necessarily applied to all signal lines.

Memory device 940 includes controller 950, which represents control logic within the memory device to control internal operations within the memory device. For example, controller 950 decodes commands sent by memory controller 920 and generates internal operations to execute or satisfy the commands. Controller 950 can be referred to as an internal controller, and is separate from memory controller 920 of the host. Controller 950 can determine what mode is selected based on register 944, and configure the internal execution of operations for access to memory resources 960 or other operations based on the selected mode. Controller 950 generates control signals to control the routing of bits within memory device 940 to provide a proper interface for the selected mode and direct a command to the proper memory locations or addresses. Controller 950 includes command logic 952, which can decode command encoding received on command and address signal lines. Thus, command logic 952 can be or include a command decoder. With command logic 952, memory device can identify commands and generate internal operations to execute requested commands.

Referring again to memory controller 920, memory controller 920 includes command (CMD) logic 924, which represents logic or circuitry to generate commands to send to memory devices 940. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 940, memory controller 920 can issue commands via I/O 922 to cause memory device 940 to execute the commands. In one example, controller 950 of memory device 940 receives and decodes command and address information received via I/O 942 from memory controller 920. Based on the received command and address information, controller 950 can control the timing of operations of the logic and circuitry within memory device 940 to execute the commands. Controller 950 is responsible for compliance with standards or specifications within memory device 940, such as timing and signaling requirements. Memory controller 920 can implement compliance with standards or specifications by access scheduling and control.

Memory controller 920 includes scheduler 930, which represents logic or circuitry to generate and order transactions to send to memory device 940. From one perspective, the primary function of memory controller 920 could be said to schedule memory access and other transactions to memory device 940. Such scheduling can include generating the transactions themselves to implement the requests for data by processor 910 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 920 typically includes logic such as scheduler 930 to allow selection and ordering of transactions to improve performance of system 900. Thus, memory controller 920 can select which of the outstanding transactions should be sent to memory device 940 in which order, which is typically achieved with logic much more complex that a simple first-in first-out algorithm. Memory controller 920 manages the transmission of the transactions to memory device 940, and manages the timing associated with the transaction. In one example, transactions have deterministic timing, which can be managed by memory controller 920 and used in determining how to schedule the transactions with scheduler 930.

In one example, memory controller 920 includes refresh (REF) logic 926. Refresh logic 926 can be used for memory resources that are volatile and need to be refreshed to retain a deterministic state. In one example, refresh logic 926 indicates a location for refresh, and a type of refresh to perform. Refresh logic 926 can trigger self-refresh within memory device 940, or execute external refreshes which can be referred to as auto refresh commands) by sending refresh commands, or a combination. In one example, controller 950 within memory device 940 includes refresh logic 954 to apply refresh within memory device 940. In one example, refresh logic 954 generates internal operations to perform refresh in accordance with an external refresh received from memory controller 920. Refresh logic 954 can determine if a refresh is directed to memory device 940, and what memory resources 960 to refresh in response to the command.

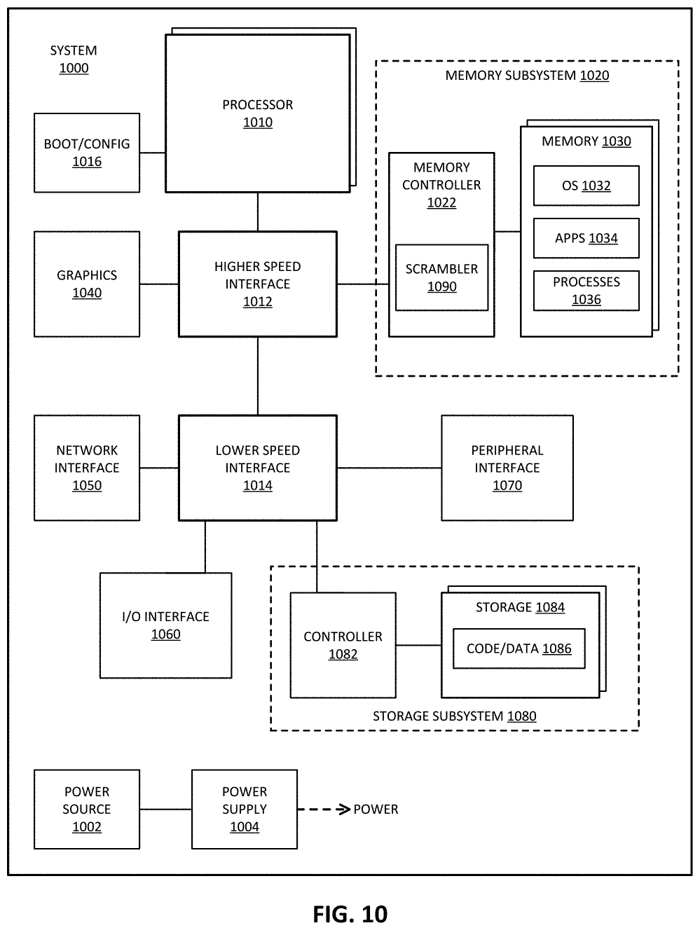

FIG. 10 is a block diagram of an example of a computing system in which data scrambling based on row address can be implemented. System 1000 represents a computing device in accordance with any example herein, and can be a laptop computer, a desktop computer, a tablet computer, a server, a gaming or entertainment control system, embedded computing device, or other electronic device.

System 1000 represents a system in accordance with an example of system 102, system 104, system 200, system 300, or system 400. In one example, memory controller 1022 includes scrambler 1090. Scrambler 1090 can scramble data for write operations in accordance with any example herein. Scrambler 1090 applies a data mask based at least in part on row address bits, which randomizes the data mask used for adjacent rows of data. Scrambler 1090 can reverse the scrambling of the data when data is read from memory 1030 in accordance with any example herein.

System 1000 includes processor 1010 can include any type of microprocessor, central processing unit (CPU), graphics processing unit (GPU), processing core, or other processing hardware, or a combination, to provide processing or execution of instructions for system 1000. Processor 1010 can be a host processor device. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or a combination of such devices.

System 1000 includes boot/config 1016, which represents storage to store boot code (e.g., basic input/output system (BIOS)), configuration settings, security hardware (e.g., trusted platform module (TPM)), or other system level hardware that operates outside of a host OS. Boot/config 1016 can include a nonvolatile storage device, such as read-only memory (ROM), flash memory, or other memory devices.

In one example, system 1000 includes interface 1012 coupled to processor 1010, which can represent a higher speed interface or a high throughput interface for system components that need higher bandwidth connections, such as memory subsystem 1020 or graphics interface components 1040. Interface 1012 represents an interface circuit, which can be a standalone component or integrated onto a processor die. Interface 1012 can be integrated as a circuit onto the processor die or integrated as a component on a system on a chip. Where present, graphics interface 1040 interfaces to graphics components for providing a visual display to a user of system 1000. Graphics interface 1040 can be a standalone component or integrated onto the processor die or system on a chip. In one example, graphics interface 1040 can drive a high definition (HD) display or ultra high definition (UHD) display that provides an output to a user. In one example, the display can include a touchscreen display. In one example, graphics interface 1040 generates a display based on data stored in memory 1030 or based on operations executed by processor 1010 or both.

Memory subsystem 1020 represents the main memory of system 1000, and provides storage for code to be executed by processor 1010, or data values to be used in executing a routine. Memory subsystem 1020 can include one or more varieties of random-access memory (RAM) such as DRAM, 3DXP (three-dimensional crosspoint), or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010, such as integrated onto the processor die or a system on a chip.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 1000 includes interface 1014, which can be coupled to interface 1012. Interface 1014 can be a lower speed interface than interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can exchange data with a remote device, which can include sending data stored in memory or receiving data to be stored in memory.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, NAND, 3DXP, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one example, storage subsystem 1080 includes controller 1082 to interface with storage 1084. In one example controller 1082 is a physical part of interface 1014 or processor 1010, or can include circuits or logic in both processor 1010 and interface 1014.

Power source 1002 provides power to the components of system 1000. More specifically, power source 1002 typically interfaces to one or multiple power supplies 1004 in system 1000 to provide power to the components of system 1000. In one example, power supply 1004 includes an AC to DC (alternating current to direct current) adapter to plug into a wall outlet. Such AC power can be renewable energy (e.g., solar power) power source 1002. In one example, power source 1002 includes a DC power source, such as an external AC to DC converter. In one example, power source 1002 or power supply 1004 includes wireless charging hardware to charge via proximity to a charging field. In one example, power source 1002 can include an internal battery or fuel cell source.

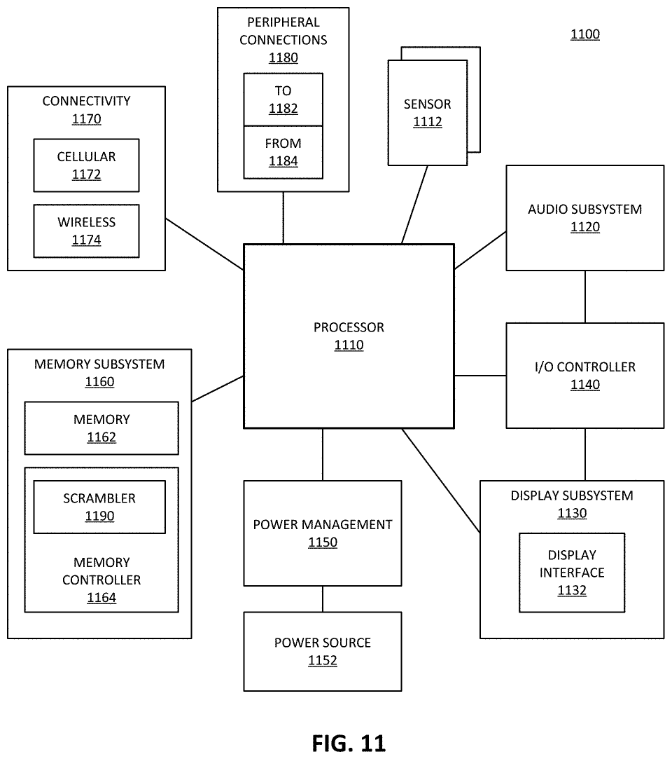

FIG. 11 is a block diagram of an example of a mobile device in which data scrambling based on row address can be implemented. System 1100 represents a mobile computing device, such as a computing tablet, a mobile phone or smartphone, wearable computing device, or other mobile device, or an embedded computing device. It will be understood that certain of the components are shown generally, and not all components of such a device are shown in system 1100.

System 1100 represents a system in accordance with an example of system 102, system 104, system 200, system 300, or system 400. In one example, memory controller 1164 includes scrambler 1190. Scrambler 1190 can scramble data for write operations in accordance with any example herein. Scrambler 1190 applies a data mask based at least in part on row address bits, which randomizes the data mask used for adjacent rows of data. Scrambler 1190 can reverse the scrambling of the data when data is read from memory 1162 in accordance with any example herein.

System 1100 includes processor 1110, which performs the primary processing operations of system 1100. Processor 1110 can be a host processor device. Processor 1110 can include one or more physical devices, such as microprocessors, application processors, microcontrollers, programmable logic devices, or other processing means. The processing operations performed by processor 1110 include the execution of an operating platform or operating system on which applications and device functions are executed. The processing operations include operations related to I/O (input/output) with a human user or with other devices, operations related to power management, operations related to connecting system 1100 to another device, or a combination. The processing operations can also include operations related to audio I/O, display I/O, or other interfacing, or a combination. Processor 1110 can execute data stored in memory. Processor 1110 can write or edit data stored in memory.

In one example, system 1100 includes one or more sensors 1112. Sensors 1112 represent embedded sensors or interfaces to external sensors, or a combination. Sensors 1112 enable system 1100 to monitor or detect one or more conditions of an environment or a device in which system 1100 is implemented. Sensors 1112 can include environmental sensors (such as temperature sensors, motion detectors, light detectors, cameras, chemical sensors (e.g., carbon monoxide, carbon dioxide, or other chemical sensors)), pressure sensors, accelerometers, gyroscopes, medical or physiology sensors (e.g., biosensors, heart rate monitors, or other sensors to detect physiological attributes), or other sensors, or a combination. Sensors 1112 can also include sensors for biometric systems such as fingerprint recognition systems, face detection or recognition systems, or other systems that detect or recognize user features. Sensors 1112 should be understood broadly, and not limiting on the many different types of sensors that could be implemented with system 1100. In one example, one or more sensors 1112 couples to processor 1110 via a frontend circuit integrated with processor 1110. In one example, one or more sensors 1112 couples to processor 1110 via another component of system 1100.

In one example, system 1100 includes audio subsystem 1120, which represents hardware (e.g., audio hardware and audio circuits) and software (e.g., drivers, codecs) components associated with providing audio functions to the computing device. Audio functions can include speaker or headphone output, as well as microphone input. Devices for such functions can be integrated into system 1100, or connected to system 1100. In one example, a user interacts with system 1100 by providing audio commands that are received and processed by processor 1110.

Display subsystem 1130 represents hardware (e.g., display devices) and software components (e.g., drivers) that provide a visual display for presentation to a user. In one example, the display includes tactile components or touchscreen elements for a user to interact with the computing device. Display subsystem 1130 includes display interface 1132, which includes the particular screen or hardware device used to provide a display to a user. In one example, display interface 1132 includes logic separate from processor 1110 (such as a graphics processor) to perform at least some processing related to the display. In one example, display subsystem 1130 includes a touchscreen device that provides both output and input to a user. In one example, display subsystem 1130 includes a high definition (HD) or ultra-high definition (UHD) display that provides an output to a user. In one example, display subsystem includes or drives a touchscreen display. In one example, display subsystem 1130 generates display information based on data stored in memory or based on operations executed by processor 1110 or both.

I/O controller 1140 represents hardware devices and software components related to interaction with a user. I/O controller 1140 can operate to manage hardware that is part of audio subsystem 1120, or display subsystem 1130, or both. Additionally, I/O controller 1140 illustrates a connection point for additional devices that connect to system 1100 through which a user might interact with the system. For example, devices that can be attached to system 1100 might include microphone devices, speaker or stereo systems, video systems or other display device, keyboard or keypad devices, buttons/switches, or other I/O devices for use with specific applications such as card readers or other devices.

As mentioned above, I/O controller 1140 can interact with audio subsystem 1120 or display subsystem 1130 or both. For example, input through a microphone or other audio device can provide input or commands for one or more applications or functions of system 1100. Additionally, audio output can be provided instead of or in addition to display output. In another example, if display subsystem includes a touchscreen, the display device also acts as an input device, which can be at least partially managed by I/O controller 1140. There can also be additional buttons or switches on system 1100 to provide I/O functions managed by I/O controller 1140.

In one example, I/O controller 1140 manages devices such as accelerometers, cameras, light sensors or other environmental sensors, gyroscopes, global positioning system (GPS), or other hardware that can be included in system 1100, or sensors 1112. The input can be part of direct user interaction, as well as providing environmental input to the system to influence its operations (such as filtering for noise, adjusting displays for brightness detection, applying a flash for a camera, or other features).

In one example, system 1100 includes power management 1150 that manages battery power usage, charging of the battery, and features related to power saving operation. Power management 1150 manages power from power source 1152, which provides power to the components of system 1100. In one example, power source 1152 includes an AC to DC (alternating current to direct current) adapter to plug into a wall outlet. Such AC power can be renewable energy (e.g., solar power, motion based power). In one example, power source 1152 includes only DC power, which can be provided by a DC power source, such as an external AC to DC converter. In one example, power source 1152 includes wireless charging hardware to charge via proximity to a charging field. In one example, power source 1152 can include an internal battery or fuel cell source.

Memory subsystem 1160 includes memory device(s) 1162 for storing information in system 1100. Memory subsystem 1160 can include nonvolatile (state does not change if power to the memory device is interrupted) or volatile (state is indeterminate if power to the memory device is interrupted) memory devices, or a combination. Memory 1160 can store application data, user data, music, photos, documents, or other data, as well as system data (whether long-term or temporary) related to the execution of the applications and functions of system 1100. In one example, memory subsystem 1160 includes memory controller 1164 (which could also be considered part of the control of system 1100, and could potentially be considered part of processor 1110). Memory controller 1164 includes a scheduler to generate and issue commands to control access to memory device 1162.

Connectivity 1170 includes hardware devices (e.g., wireless or wired connectors and communication hardware, or a combination of wired and wireless hardware) and software components (e.g., drivers, protocol stacks) to enable system 1100 to communicate with external devices. The external device could be separate devices, such as other computing devices, wireless access points or base stations, as well as peripherals such as headsets, printers, or other devices. In one example, system 1100 exchanges data with an external device for storage in memory or for display on a display device. The exchanged data can include data to be stored in memory, or data already stored in memory, to read, write, or edit data.

Connectivity 1170 can include multiple different types of connectivity. To generalize, system 1100 is illustrated with cellular connectivity 1172 and wireless connectivity 1174. Cellular connectivity 1172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), 5G, or other cellular service standards. Wireless connectivity 1174 refers to wireless connectivity that is not cellular, and can include personal area networks (such as Bluetooth), local area networks (such as WiFi), or wide area networks (such as WiMax), or other wireless communication, or a combination. Wireless communication refers to transfer of data through the use of modulated electromagnetic radiation through a non-solid medium. Wired communication occurs through a solid communication medium.

Peripheral connections 1180 include hardware interfaces and connectors, as well as software components (e.g., drivers, protocol stacks) to make peripheral connections. It will be understood that system 1100 could both be a peripheral device (“to” 1182) to other computing devices, as well as have peripheral devices (“from” 1184) connected to it. System 1100 commonly has a “docking” connector to connect to other computing devices for purposes such as managing (e.g., downloading, uploading, changing, synchronizing) content on system 1100. Additionally, a docking connector can allow system 1100 to connect to certain peripherals that allow system 1100 to control content output, for example, to audiovisual or other systems.

In addition to a proprietary docking connector or other proprietary connection hardware, system 1100 can make peripheral connections 1180 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), or other type.

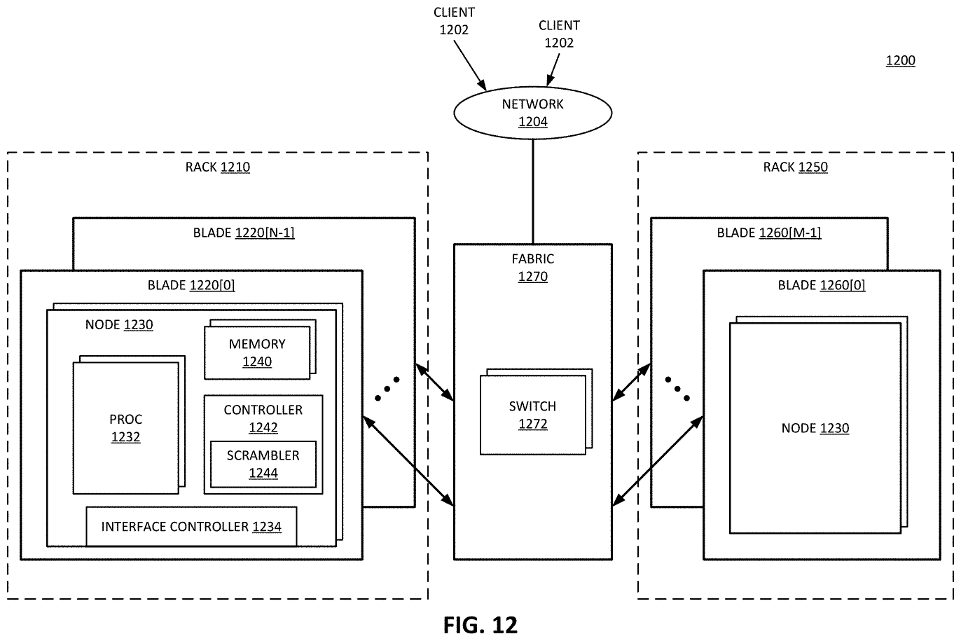

FIG. 12 is a block diagram of an example of a multi-node network in which data scrambling based on row address can be implemented. System 1200 represents a network of nodes that can apply adaptive ECC. In one example, system 1200 represents a data center. In one example, system 1200 represents a server farm. In one example, system 1200 represents a data cloud or a processing cloud.

Node represents a system in accordance with an example of system 102, system 104, system 200, system 300, or system 400. Node 1230 includes memory 1240. Node 1230 includes controller 1242, which represents a memory controller to manage access to memory 1240. In one example, controller 1242 includes scrambler 1244, which represents logic to enable the memory to perform data scrambling and reversing of the scrambling. The scrambling can be in accordance with any example herein. The scrambling includes row address information and can include a per-boot seed value.

One or more clients 1202 make requests over network 1204 to system 1200. Network 1204 represents one or more local networks, or wide area networks, or a combination. Clients 1202 can be human or machine clients, which generate requests for the execution of operations by system 1200. System 1200 executes applications or data computation tasks requested by clients 1202.

In one example, system 1200 includes one or more racks, which represent structural and interconnect resources to house and interconnect multiple computation nodes. In one example, rack 1210 includes multiple nodes 1230. In one example, rack 1210 hosts multiple blade components 1220. Hosting refers to providing power, structural or mechanical support, and interconnection. Blades 1220 can refer to computing resources on printed circuit boards (PCBs), where a PCB houses the hardware components for one or more nodes 1230. In one example, blades 1220 do not include a chassis or housing or other “box” other than that provided by rack 1210. In one example, blades 1220 include housing with exposed connector to connect into rack 1210. In one example, system 1200 does not include rack 1210, and each blade 1220 includes a chassis or housing that can stack or otherwise reside in close proximity to other blades and allow interconnection of nodes 1230.

System 1200 includes fabric 1270, which represents one or more interconnectors for nodes 1230. In one example, fabric 1270 includes multiple switches 1272 or routers or other hardware to route signals among nodes 1230. Additionally, fabric 1270 can couple system 1200 to network 1204 for access by clients 1202. In addition to routing equipment, fabric 1270 can be considered to include the cables or ports or other hardware equipment to couple nodes 1230 together. In one example, fabric 1270 has one or more associated protocols to manage the routing of signals through system 1200. In one example, the protocol or protocols is at least partly dependent on the hardware equipment used in system 1200.

As illustrated, rack 1210 includes N blades 1220. In one example, in addition to rack 1210, system 1200 includes rack 1250. As illustrated, rack 1250 includes M blades 1260. M is not necessarily the same as N; thus, it will be understood that various different hardware equipment components could be used, and coupled together into system 1200 over fabric 1270. Blades 1260 can be the same or similar to blades 1220. Nodes 1230 can be any type of node and are not necessarily all the same type of node. System 1200 is not limited to being homogenous, nor is it limited to not being homogenous.

For simplicity, only the node in blade 1220[0] is illustrated in detail. However, other nodes in system 1200 can be the same or similar. At least some nodes 1230 are computation nodes, with processor (proc) 1232 and memory 1240. A computation node refers to a node with processing resources (e.g., one or more processors) that executes an operating system and can receive and process one or more tasks. In one example, at least some nodes 1230 are server nodes with a server as processing resources represented by processor 1232 and memory 1240. A storage server refers to a node with more storage resources than a computation node, and rather than having processors for the execution of tasks, a storage server includes processing resources to manage access to the storage nodes within the storage server.

In one example, node 1230 includes interface controller 1234, which represents logic to control access by node 1230 to fabric 1270. The logic can include hardware resources to interconnect to the physical interconnection hardware. The logic can include software or firmware logic to manage the interconnection. In one example, interface controller 1234 is or includes a host fabric interface, which can be a fabric interface in accordance with any example described herein.

Processor 1232 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 1240 can be or include memory devices and a memory controller.

In general with respect to the descriptions herein, in one example a memory controller includes: input/output (I/O) interface hardware to couple to a data bus to interconnect with a memory device having a memory array, the memory device to store data in the memory array based at least in part on row address; and scrambler circuitry to apply a data mask to scramble data to send over the data bus to the memory device, the data mask having a pseudorandom pattern based at least in part on the row address.

In one example of the memory controller, the data mask comprises a mask generated from selected bits of the row address. In accordance with any preceding example of the memory controller, in one example, the selected bits of the row address comprise least significant bits of the row address. In accordance with any preceding example of the memory controller, in one example, the data mask further comprises selected bits of one or more of column address bits, rank address bits, or bank group address bits. In accordance with any preceding example of the memory controller, in one example, the data mask comprises seed bits that change with each boot of the memory controller. In accordance with any preceding example of the memory controller, in one example, the data mask comprises an exclusive OR (XOR) mask to XOR with data to write to the memory array. In accordance with any preceding example of the memory controller, in one example, the scrambler is further to unscramble data returned on the data bus for a read operation. In accordance with any preceding example of the memory controller, in one example, the memory controller includes a linear feedback shift register (LFSR) to generate the pseudorandom pattern based on a seed value, wherein the seed value includes the row address.

In general with respect to the descriptions herein, in one example a system includes: multiple dynamic random access memory (DRAM) devices coupled to a data bus, the memory devices to store data in respective memory arrays based at least in part on row address; and a memory controller coupled to the DRAM devices on the data bus, the memory controller including scrambler circuitry to apply a data mask to scramble data to send over the data bus to the memory device, the data mask having a pseudorandom pattern based at least in part on the row address.

In accordance with any preceding example of the system, in one example, the selected bits of the row address comprise least significant bits of the row address. In accordance with any preceding example of the system, in one example, the data mask further comprises selected bits of one or more of column address bits, rank address bits, or bank group address bits. In accordance with any preceding example of the system, in one example, the data mask comprises seed bits that change with each boot of the system. In accordance with any preceding example of the system, in one example, the data mask comprises an exclusive OR (XOR) mask to XOR with data to write to the memory array. In accordance with any preceding example of the system, in one example, the scrambler is further to unscramble data returned on the data bus for a read operation. In accordance with any preceding example of the system, in one example, the memory controller includes a linear feedback shift register (LFSR) to generate the pseudorandom pattern based on a seed value, wherein the seed value includes the row address. In accordance with any preceding example of the system, in one example, the system includes one or more of: a host processor device coupled to the memory controller; a display communicatively coupled to a host processor; a network interface communicatively coupled to a host processor; or a battery to power the system.

In general with respect to the descriptions herein, in one example a method includes: applying a data mask to scramble data for a write operation to a memory device having a memory array that stores data based at least in part on a row address, the data mask having a pseudorandom pattern based at least in part on the row address; and sending the scrambled data over a data bus to the memory device, the memory device to store the scrambled data in the memory array.

In one example of the method, the data mask comprises a mask generated from selected bits of the row address. In accordance with any preceding example of the method, in one example, the selected bits of the row address comprise least significant bits of the row address. In accordance with any preceding example of the method, in one example, the data mask comprises seed bits that change with each boot of a system that includes the memory device. In accordance with any preceding example of the method, in one example, the method includes: unscrambling data returned on the data bus for a read operation. In accordance with any preceding example of the method, in one example, the method includes: generating the pseudorandom pattern with a linear feedback shift register (LFSR) based on a seed value, wherein the seed value includes the row address.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory controller, comprising:
input/output (I/O) interface hardware to couple to a data bus to interconnect with a memory device having a memory array, the memory device to store data in the memory array based at least in part on a row address; and
scrambler circuitry to apply a data mask to scramble data to send over the data bus to the memory device, the data mask having a pseudorandom pattern based at least in part on the row address.

2. The memory controller of claim 1, wherein the data mask comprises a mask generated from selected bits of the row address.

3. The memory controller of claim 2, wherein the selected bits of the row address comprise least significant bits of the row address.

4. The memory controller of claim 2, wherein the data mask further comprises selected bits of one or more of column address bits, rank address bits, or bank group address bits.

5. The memory controller of claim 2, wherein the data mask comprises seed bits that change with each boot of the memory controller.

6. The memory controller of claim 1, wherein the data mask comprises an exclusive OR (XOR) mask to XOR with data to write to the memory array.

7. The memory controller of claim 6, wherein the scrambler is further to unscramble data returned on the data bus for a read operation.

8. The memory controller of claim 1, further comprising a linear feedback shift register (LFSR) to generate the pseudorandom pattern based on a seed value, wherein the seed value includes the row address.

9. A system, comprising:
multiple dynamic random access memory (DRAM) devices coupled to a data bus, the memory devices to store data in respective memory arrays based at least in part on a row address; and
a memory controller coupled to the DRAM devices on the data bus, the memory controller including scrambler circuitry to apply a data mask to scramble data to send over the data bus to the memory device, the data mask having a pseudorandom pattern based at least in part on the row address.

10. The system of claim 9, wherein the data mask comprises a mask generated from selected bits of the row address.

11. The system of claim 10, wherein the selected bits of the row address comprise least significant bits of the row address.

12. The system of claim 9, wherein the data mask comprises seed bits that change with each boot of the memory controller.

13. The system of claim 9, wherein the data mask comprises an exclusive OR (XOR) mask to XOR with data to write to the memory array.

14. The system of claim 9, the memory controller further comprising a linear feedback shift register (LFSR) to generate the pseudorandom pattern based on a seed value, wherein the seed value includes the row address.

15. The system of claim 9, further comprising one or more of:
a host processor device coupled to the memory controller;
a display communicatively coupled to a host processor;
a network interface communicatively coupled to a host processor; or
a battery to power the system.

16. A method comprising:
applying a data mask to scramble data for a write operation to a memory device having a memory array that stores data based at least in part on a row address, the data mask having a pseudorandom pattern based at least in part on the row address; and
sending the scrambled data over a data bus to the memory device, the memory device to store the scrambled data in the memory array.

17. The method of claim 16, wherein the data mask comprises a mask generated from selected bits of the row address.

18. The method of claim 17, wherein the selected bits of the row address comprise least significant bits of the row address.

19. The method of claim 17, wherein the data mask comprises seed bits that change with each boot of a system that includes the memory device.

20. The method of claim 19, further comprising:
unscrambling data returned on the data bus for a read operation.

21. The method of claim 17, further comprising:
generating the pseudorandom pattern with a linear feedback shift register (LFSR) based on a seed value, wherein the seed value includes the row address.
